(19) United States
(12) Patent Application Publication
(10) Pub. No.: US 2009/0216379 A1
(43) Pub. Date: Aug. 27, 2009

(54) METHOD OF CONTROLLING THE OPERATION OF AN ELECTRONIC DEVICE

(76) Inventor: Michael Smith, Mesa, AZ (US)

Correspondence Address: SCHMEISER OLSEN & WATTS, 18 E UNIVERSITY DRIVE, SUITE # 101, MESA, AZ, 85201, US

(21) Appl. No.: 12/395,124

(22) Filed: Feb. 27, 2009

Related U.S. Application Data
(60) Provisional application No. 61/032,029, filed on Feb. 27, 2008.

(51) Int. Cl. G05B 15/00; F25B 49/00; G05D 23/00

(52) U.S. Cl. 700/275; 62/126; 62/157; 700/299; 236/46 R

(57) ABSTRACT

A method of operating an electronic system includes determining first and second temperature signals with a thermostat processor. The first and second temperature signals are provided by a temperature sensor. The method includes adjusting the operation of an air conditioning unit in response to an indication that a difference between the first and second signals is within a predetermined range. The second temperature signal is provided in response to an indication from a timer.

### CROSS-REFERENCE TO RELATED APPLICATIONS

This patent application claims priority to U.S. Provisional Application No. 61/032,029, which was filed on Feb. 27, 2008, the contents of which are incorporated herein by reference.

### BACKGROUND OF THE INVENTION

1. Field of the Invention

This invention relates to an electronic device which is responsive to a temperature sensor.

2. Description of the Related Art

Temperature sensors are often used to control the operation of an electronic device. Examples of such systems include a thermostat and air conditioning unit. More information regarding thermostats and air conditioning units is provided in U.S. Pat. Nos. 4,663,951, 4,969,508, 5,244,146, 5,361,982 and 6,619,055. An air conditioning system is used to control the temperature of a space, such as a room. In some situations, the air conditioning system increases the temperature of the space by providing heated air and, in other situations, the air conditioning system decreases the temperature of the space by providing cooled air. In some situations, the thermostat is set to a desired temperature, and the air conditioning system drives the temperature of the space to the desired temperature.

Most thermostats include a thermostat processor operatively coupled with a temperature sensor, wherein the temperature sensor determines the temperature of the space. In operation, the thermostat processor drives the operation of the air conditioning system in response to a temperature signal provided by the temperature sensor. For example, the air conditioning system provides cool air in response to the temperature sensor providing an indication to the thermostat processor that the space is too hot. Further, the air conditioning system provides hot air in response to the temperature sensor providing an indication to the thermostat processor that the space is too cool. In this way, the temperature of the space is controlled by the thermostat processor in response to an indication from the temperature sensor.

However, one problem is that the temperature of the space proximate to the temperature sensor can be changed. For example, a heating pad is positioned proximate to the temperature sensor so that the temperature sensor provides a false indication to the thermostat processor that the space is too hot. The air conditioning system will provide cool air to the space in response to this false temperature indication. In another example, ice is positioned proximate to the temperature sensor so that the temperature sensor provides a false indication to the thermostat processor that the space is too cool. The air conditioning system will provide hot air to the space in response to this false temperature indication.

It is desirable to provide a thermostat which is less susceptible to being operated in response to false temperature indications.

### BRIEF SUMMARY OF THE INVENTION

The present invention provides a system, which includes a processor operatively coupled with a temperature sensor and timer, and an electronic device operatively coupled with the processor. The processor provides an output signal to the electronic device in response to receiving a temperature signal from the temperature sensor for a predetermined amount of time. The predetermined amount of time is determined by the timer.

In some embodiments, the processor is a thermostat processor. In some embodiments, the electronic device is an air conditioning unit. In some embodiments, the processor compares first and second temperature signals from the temperature sensor. In some of these embodiments, the second temperature signal is determined in response to an indication from the timer.

The present invention provides a system, which includes an electronic device, and a processor operatively coupled with the electronic device. The system includes a temperature sensor and timer operatively coupled with the processor. The processor determines a temperature change of the temperature sensor within a predetermined amount of time determined by the timer. The processor allows and restricts the adjustment of the operation of the electronic device in response to a determination that the temperature change is less than and greater than, respectively, a predetermined temperature change.

In some embodiments, the timer is started in response to an indication from the processor that the temperature of the temperature sensor is changing. In some embodiments, the timer is reset in response to an indication from the processor that the temperature of the temperature sensor is changing.

In some embodiments, the processor is a thermostat processor, and the electronic device is an air conditioning unit. In some of these embodiments, the air conditioning unit adjusts the temperature of a space in response to the determination that the temperature change is less than the predetermined temperature change.

The present invention employs a method of operating a system, which includes determining first and second temperature signals with a processor, wherein the first and second temperature signals is provided by a temperature sensor. The method includes adjusting the operation of an electronic device in response to an indication that a difference between the first and second signals is within a predetermined range.

In some embodiments, the second temperature signal is provided in response to an indication from a timer. In some embodiments, the processor compares the first and second temperature signals from the temperature sensor. In some of these embodiments, the processor allows the adjustment of the operation of the electronic device in response to an indication that the difference between the first and second signals is within a predetermined range.

In some embodiments, the method includes restricting the adjustment of operation of the electronic device in response to an indication that a difference between the first and second signals is not within the predetermined range. In some embodiments, the processor restricts the adjustment of the operation of the electronic device in response to an indication that a difference between the first and second signals is not within the predetermined range.

The present invention employs a method of operating an electronic system which includes providing a first temperature signal to a processor with a temperature sensor, and providing a second temperature signal to the processor with the temperature sensor, wherein the second signal is provided after a predetermined amount of time. The method includes adjusting the operation of an electronic device in response to an indication that a difference between the first and second signals is within a predetermined range.

In some embodiments, the predetermined amount of time is determined by a timer. In some embodiments, the second temperature signal is provided in response to an indication to the processor from a timer. In some embodiments, the processor compares the first and second temperature signals from the temperature sensor.

In some embodiments, the method includes restricting the adjustment of the operation of the electronic device in response to an indication that a difference between the first and second signals is not within the predetermined range.

In some embodiments, the processor allows the adjustment of the operation of the electronic device in response to an indication that the difference between the first and second signals is within a predetermined range. In some of these embodiments, the processor is a thermostat processor. Further, in some of these embodiments, the electronic device is an air conditioning unit. The air conditioning unit adjusts the temperature of a space in response to the indication.

These and other features, aspects, and advantages of the present invention will become better understood with reference to the following drawings and description.

### BRIEF DESCRIPTION OF THE DRAWINGS

FIG. 1 is a block diagram of a system having a processor which allows and restricts the adjustment of the operation of an electronic device in response to a temperature change.

FIG. 2 is a graph which illustrates the operation of system according to a first mode of operation.

FIG. 3 is a graph which illustrates the operation of system according to a second mode of operation.

FIGS. 4, 5, 6, 7 and 8 are flow diagrams of methods, in accordance with the invention, of operating a system having a processor which allows and restricts the adjustment of the operation of an electronic device in response to a temperature change.

### DETAILED DESCRIPTION OF THE INVENTION

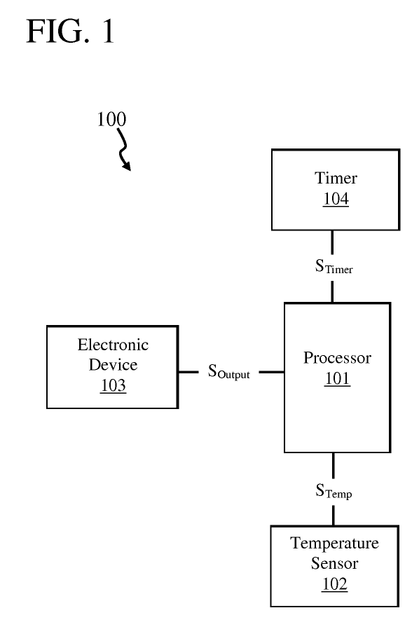

FIG. 1 is a block diagram of a system 100, in accordance with the invention, which includes a processor 101 operatively coupled with a temperature sensor 102 and timer 104. System 100 includes an electronic device 103 operatively coupled with processor 101. In a first mode of operation, processor 101 provides an output signal S_{Output} to electronic device 103 in response to receiving a temperature signal S_{Temp} from temperature sensor 102 for a predetermined amount of time, t_{Pred}. Predetermined amount of time t_{Pred} can be determined in many different ways, such as by using timer 104. The processor can be of many different types, such as a thermostat processor. The electronic device can be of many different types, such as an air conditioning unit. The timer can be of many different types, such as a 555 timer by Phillips Electronics. The timer can be a software-based watchdog timer, such as that disclosed in U.S. Pat. No. 7,162,714, the contents of which are incorporated herein by reference.

System 100 can operate in many different ways. For example, in one embodiment processor 101 compares first and second temperature signals S_{Temp1} and S_{Temp2} from temperature sensor 102. Temperature signals S_{Temp2} is determined in response to an indication from timer 104. Temperature signals S_{Temp2} can be determined in response to the indication from timer 104 in many different ways, such as by having timer 104 provide a signal S_{Timer} to processor 101. Processor 101 determines temperature signal S_{Temp2} in response to receiving signal S_{Timer} from timer 104.

FIG. 2 is a graph 110 which illustrates the operation of system 100 according to the first mode of operation. Graph 110 is a graph of temperature T verses time t for the temperature provided to processor 101 by temperature sensor 102. In graph 110, as well as the other graphs discussed herein, time t₁ is less than time t₂, time t₂ is less than time t₃, time t₃ is less than time t₄, time t₄ is less than time t₅ and time t₅ is less than time t₆. Further, temperature T₁ is less than temperature T₂, temperature T₂ is less than temperature T₃ and temperature t₃ is less than temperature T₄. In graph 110, time t_{Pred} is equal to the difference between times t₁ and t₂. Time t_{Pred} is equal to the difference between times t₃ and t₂. Further, time t_{Pred} is equal to the difference between times t₄ and t₃, etc. Timer 104 counts for time t_{Pred} and then it is reset in response to a signal from processor 101 and begins counting again.

In graph 110, the temperature provided by temperature sensor 102 to processor 101 is equal to temperature T₁ when the time is less than time t₁. At time t₁, timer 104 is reset and the temperature provided by temperature sensor 102 to processor 101 increases. The temperature provided by temperature sensor 102 to processor 101 increases so that the temperature is temperature T₂ when the time is equal to time t₂, and timer 104 is reset again. Processor 101 compares temperatures T₁ and T₂ to each other and determines the difference between them. If the difference between temperatures T₁ and T₂ is less than a predetermined temperature difference ΔT_{Diff}, then processor 101 is allowed to adjust the operation of electronic device 103. If the difference between temperatures T₁ and T₂ is greater than predetermined temperature difference ΔT_{Diff}, then processor 101 is restricted from adjusting the operation of electronic device 103.

For example, in graph 110, the temperature provided by temperature sensor 102 to processor 101 is temperature T₂ at time t₂, and temperature T₄ at time t₃. Processor 101 determines the difference between temperatures T₄ and T₃ which is about twice the value of predetermined temperature difference ΔT_{Diff}. Because the difference between temperatures T₄ and T₃ is greater than predetermined temperature difference ΔT_{Diff}, processor 101 is restricted from adjusting the operation of electronic device 103.

In a second mode of operation, system 100 includes processor 101 operatively coupled with electronic device 103, temperature sensor 102 and timer 104. In this mode of operation, processor 101 determines a temperature change of temperature sensor 102 within a predetermined amount of time Δt_{Pred} determined by timer 104. Processor 101 allows and restricts the adjustment of the operation of electronic device 103 in response to a determination that temperature change ΔT is less than and greater than, respectively, a predetermined temperature change ΔT_{Pred}.

It should be noted that, in some embodiments, processor 101 is allowed to adjust the operation of electronic device 103 in response to a determination that temperature change ΔT is equal to predetermined temperature change ΔT_{Pred}. In other embodiments, processor 101 restricts the adjustment of the operation of electronic device 103 in response to a determination that temperature change ΔT is equal to predetermined temperature change ΔT_{Pred}. The ability of processor 101 to be able to adjust and restrict the operation of electronic device 103 in response to a determination that temperature change ΔT is equal to predetermined temperature change ΔT_{Pred} can be chosen, such as by the end user.

In some embodiments, timer 104 is started in response to an indication from processor 101 that the temperature T of temperature sensor 102 is changing. Timer 104 is started when it begins its counting sequence.

In some embodiments, timer 104 is reset in response to an indication from processor 101 that temperature T of temperature sensor 102 is changing. In some situations, timer 104 is reset when its counting sequence is started again. It is desirable to start the counting sequence again in response to an indication that temperature change ΔT is less than predetermined temperature change ΔT_{Pred}. In other situations, timer 104 is reset when its counting sequence is stopped. It is desirable to stop the counting sequence of timer 104 in response to temperature change ΔT being driven to zero.

In some embodiments, processor 101 is a thermostat processor, and electronic device 103 is an air conditioning unit. In these embodiments, the air conditioning unit adjusts the temperature of a space in response to the determination that temperature change ΔT is less than the predetermined temperature change ΔT_{Pred}. Further, in these embodiments, the air conditioning unit is restricted from adjusting the temperature of the space in response to the determination that temperature change ΔT is greater than the predetermined temperature change ΔT_{Pred}.

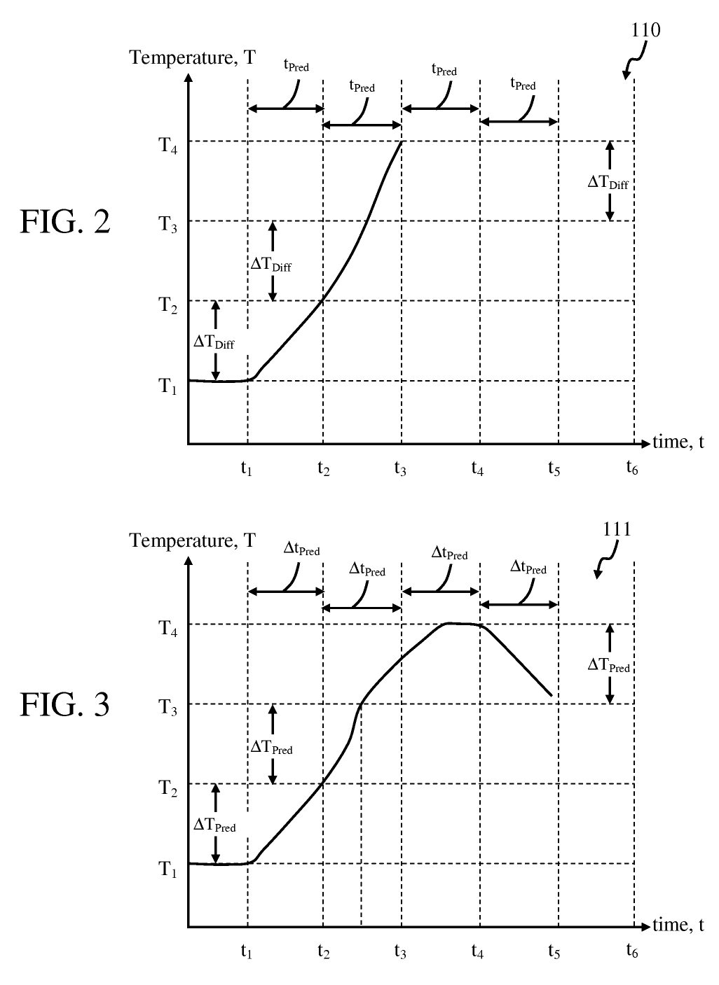

FIG. 3 is a graph 111 which illustrates the operation of system 100 according to the second mode of operation. In graph 111, the temperature provided by temperature sensor 102 to processor 101 is equal to temperature T₁ when the time is less than time t₁. At time t₁, the temperature provided by temperature sensor 102 to processor 101 increases. In response to this increase in temperature, processor 101 provides an indication to timer 104, and timer 104 begins counting in response. The temperature provided by temperature sensor 102 to processor 101 increases so that the temperature is temperature T₂ when the time is equal to time t₂.

In this embodiment, processor 101 is allowed to adjust the operation of electronic device 103 if the difference between times t₁ and t₂ is less than or equal to predetermined amount of time Δt_{Pred}. In this particular example, the differences between times t₁ and t₂ is equal to time Δt_{Pred} so processor 101 can adjust the operation of electronic device 103. For example, in the embodiment wherein processor 101 is a thermostat processor and electronic device 103 is an air conditioning unit, the thermostat processor is allowed to adjust the operation of the air conditioning unit to drive the temperature of a space to a desired temperature.

In graph 111, the temperature provided by temperature sensor 102 to processor 101 is increased after time t₂. In response to this increase in temperature, processor 101 resets timer 104 so that it begins counting again. The temperature provided by temperature sensor 102 to processor 101 increases so that the temperature is temperature T₃ when the time is equal to time t₂₃, wherein time t₂₃ is greater than time t₂ and less than time t₃. As mentioned above, processor 101 is allowed to adjust the operation of electronic device 103 if the difference between times t₁ and t₂ is less than or equal to predetermined amount of time Δt_{Pred}.

In this particular example, the differences between times t₁ and t₂ is equal to time Δt_{Pred} so that the difference between times t₂₃ and t₁ is less than time Δt_{Pred}. Since the difference between times t₂₃ and t₁ is less than time Δt_{Pred}, timer 104 has not expired because it has not had enough time to count to the desired count value. In response to timer 104 not expiring, processor 101 is restricted from adjusting the operation of electronic device 103. For example, in the embodiment wherein processor 101 is a thermostat processor and electronic device 103 is an air conditioning unit, the thermostat processor is not allowed to adjust the operation of the air conditioning unit to drive the temperature of a space to a desired temperature.

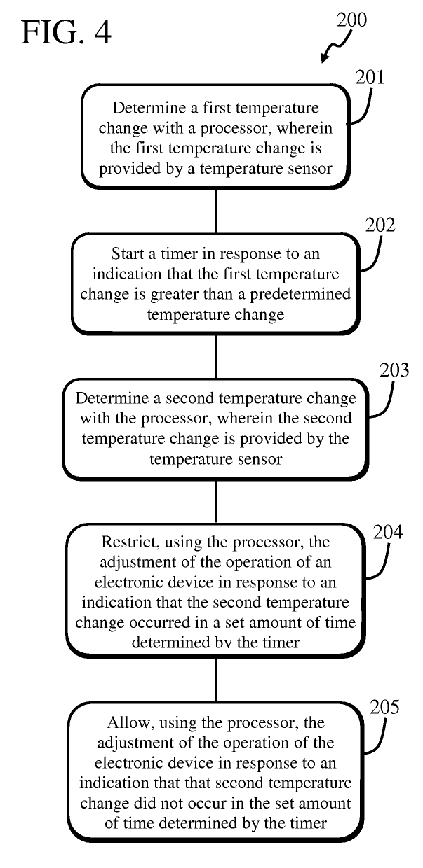

FIG. 4 is a flow diagram of a method 200, in accordance with the invention, of operating a system. In this embodiment, method 200 includes a step 201 of determining a first temperature change with a processor, wherein the first temperature change is provided by a temperature sensor. Method 200 includes a step 202 of starting a timer in response to an indication that the first temperature change is greater than a predetermined temperature change. Method 200 includes a step 203 of determining a second temperature change with the processor, wherein the second temperature change is provided by the temperature sensor. Method 200 includes a step 204 of restricting, using the processor, the adjustment of the operation of an electronic device in response to an indication that the second temperature change occurred in a set amount of time determined by the timer. In some embodiments, method 200 includes as step 205 of allowing, using the processor, the adjustment of the operation of the electronic device in response to an indication that that second temperature change did not occur in the set amount of time determined by the timer.

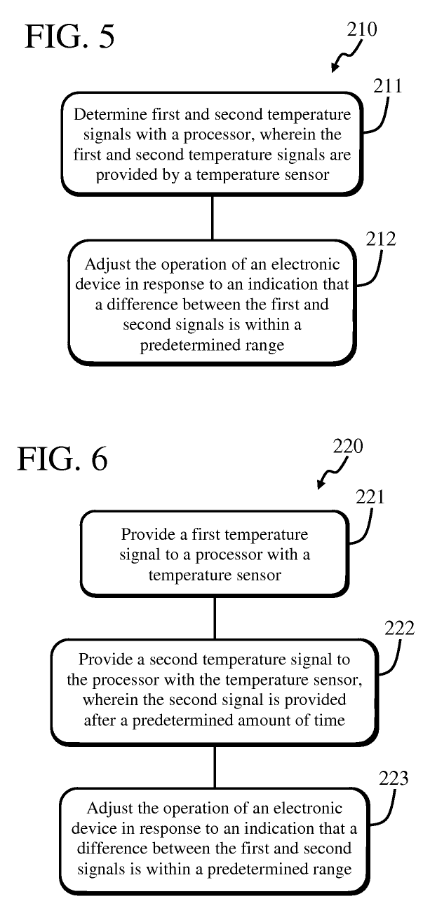

FIG. 5 is a flow diagram of a method 210, in accordance with the invention, of operating a system. In this embodiment, method 210 includes a step 211 of determining first and second temperature signals with a processor, wherein the first and second temperature signals are provided by a temperature sensor. Method 210 includes a step 212 of adjusting the operation of an electronic device in response to an indication that a difference between the first and second signals is within a predetermined range.

In some embodiments, method 210 includes a step of restricting the adjustment of operation of the electronic device in response to an indication that a difference between the first and second signals is not within the predetermined range. In some embodiments, the processor restricts the adjustment of the operation of the electronic device in response to an indication that a difference between the first and second signals is not within the predetermined range.

In some embodiments, the processor compares the first and second temperature signals from the temperature sensor. In some of these embodiments, the processor allows the adjustment of the operation of the electronic device in response to an indication that the difference between the first and second signals is within a predetermined range. In some embodiments, the second temperature signal is provided in response to an indication from a timer.

FIG. 6 is a flow diagram of a method 220, in accordance with the invention, of operating a system. In this embodiment, method 220 includes a step 221 of providing a first temperature signal to a processor with a temperature sensor. Method 220 includes a step 222 of providing a second temperature signal to the processor with the temperature sensor, wherein the second signal is provided after a predetermined amount of time. In this embodiment, method 220 includes a step 223 of adjusting the operation of an electronic device in response to an indication that a difference between the first and second signals is within a predetermined range.

In some embodiments, the predetermined amount of time is determined by a timer. In some embodiments, the second temperature signal is provided in response to an indication to the processor from a timer. In some embodiments, the processor compares the first and second temperature signals from the temperature sensor.

In some embodiments, method 220 includes a step of restricting the adjustment of the operation of the electronic device in response to an indication that a difference between the first and second signals is not within the predetermined range. In some embodiments, the processor allows the adjustment of the operation of the electronic device in response to an indication that the difference between the first and second signals is within a predetermined range.

In some embodiments, the processor is a thermostat processor, and the electronic device is an air conditioning unit. In these embodiments, the air conditioning unit adjusts the temperature of a space in response to the indication. In general, the thermostat processor allows the adjustment of the operation of the air conditioning unit in response to an indication that the difference between the first and second signals is within a predetermined range.

Further, in these embodiments, the air conditioning unit is restricted from adjusting the temperature of the space in response to the indication. In general, the air conditioning unit is restricted from adjusting the temperature of the space in response to an indication that a difference between the first and second signals is not within the predetermined range, as determined by the thermostat processor.

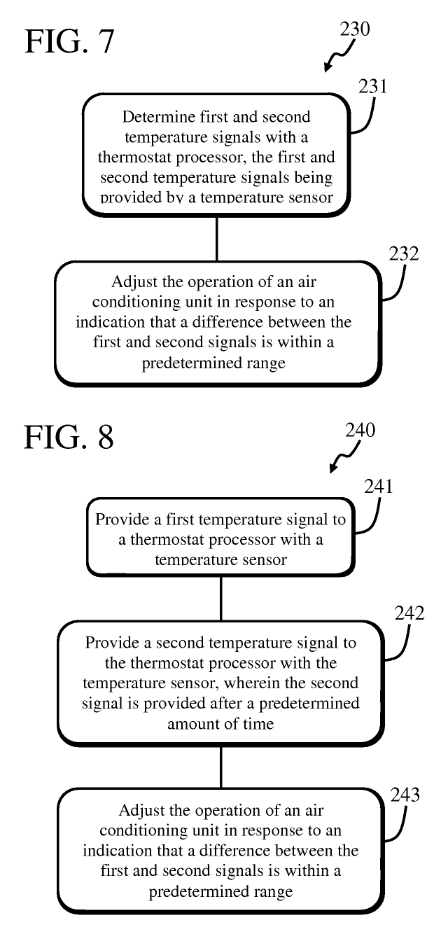

FIG. 7 is a flow diagram of a method 230, in accordance with the invention, of operating an electronic system. In this embodiment, method 230 includes a step 231 of determining first and second temperature signals with a thermostat processor. The first and second temperature signals are provided by a temperature sensor. Method 230 includes a step 232 of adjusting the operation of an air conditioning unit in response to an indication that a difference between the first and second signals is within a predetermined range. The second temperature signal is provided in response to an indication from a timer.

Method 230 can include many other steps. For example, in some embodiments, method 230 includes the thermostat processor comparing the first and second temperature signals from the temperature sensor. In some embodiments, method 230 includes restricting the adjustment of operation of the air conditioning unit in response to an indication that a difference between the first and second signals is not within the predetermined range.

FIG. 8 is a flow diagram of a method 240, in accordance with the invention, of operating an electronic system. In this embodiment, method 240 includes a step 241 of providing a first temperature signal to a thermostat processor with a temperature sensor, and a step 242 of providing a second temperature signal to the thermostat processor with the temperature sensor, wherein the second signal is provided after a predetermined amount of time. The predetermined amount of time is typically determined by a timer. The second temperature signal is provided in response to an indication to the thermostat processor from a timer. Method 240 includes a step 243 of adjusting the operation of an air conditioning unit in response to an indication that a difference between the first and second signals is within a predetermined range.

Method 240 can include many other steps. For example, in some embodiments, method 240 includes the thermostat processor comparing the first and second temperature signals from the temperature sensor. In some embodiments, method 240 includes restricting the adjustment of the operation of the air conditioning unit in response to an indication that a difference between the first and second signals is not within the predetermined range.

The embodiments of the invention described herein are exemplary and numerous modifications, variations and rearrangements can be readily envisioned to achieve substantially equivalent results, all of which are intended to be embraced within the spirit and scope of the invention.

1. A system, comprising:
a processor operatively coupled with a temperature sensor and timer;
an electronic device operatively coupled with the processor;
wherein the processor provides an output signal to the electronic device in response to receiving a temperature signal from the temperature sensor for a predetermined amount of time, the predetermined amount of time being determined by the timer.

2. The system of claim 1, wherein the processor is a thermostat processor.

3. The system of claim 1, wherein the electronic device is an air conditioning unit.

4. The system of claim 1, wherein the processor compares first and second temperature signals from the temperature sensor.

5. The system of claim 4, wherein the second temperature signal is determined in response to an indication from the timer.

6. A method of operating a system, comprising:
determining first and second temperature signals with a processor, the first and second temperature signals being provided by a temperature sensor; and
adjusting the operation of an electronic device in response to an indication that a difference between the first and second signals is within a predetermined range.

7. The method of claim 6, wherein second temperature signal is provided in response to an indication from a timer.

8. The method of claim 6, wherein the processor compares the first and second temperature signals from the temperature sensor.

9. The method of claim 8, wherein the processor allows the adjustment of the operation of the electronic device in response to an indication that the difference between the first and second signals is within a predetermined range.

10. The method of claim 6, further including restricting the adjustment of operation of the electronic device in response to an indication that a difference between the first and second signals is not within the predetermined range.

11. The method of claim 6, wherein the processor restricts the adjustment of the operation of the electronic device in response to an indication that a difference between the first and second signals is not within the predetermined range.

12. A method of operating an electronic system, comprising:
providing a first temperature signal to a processor with a temperature sensor;
providing a second temperature signal to the processor with the temperature sensor, wherein the second signal is provided after a predetermined amount of time; and
adjusting the operation of an electronic device in response to an indication that a difference between the first and second signals is within a predetermined range.

13. The method of claim 12, wherein the predetermined amount of time is determined by a timer.

14. The method of claim 12, wherein the second temperature signal is provided in response to an indication to the processor from a timer.

15. The method of claim 12, wherein the processor compares the first and second temperature signals from the temperature sensor.

16. The method of claim 12, further including restricting the adjustment of the operation of the electronic device in response to an indication that a difference between the first and second signals is not within the predetermined range.

17. The method of claim 12, wherein the processor allows the adjustment of the operation of the electronic device in response to an indication that the difference between the first and second signals is within a predetermined range.

18. The method of claim 17, wherein the processor is a thermostat processor.

19. The method of claim 17, wherein the electronic device is an air conditioning unit.

20. The method of claim 17, wherein the air conditioning unit adjusts the temperature of a space in response to the indication.
